(19) United States
(12) Patent Application Publication
(10) Pub. No.: US 2016/0173456 A1
(43) Pub. Date: Jun. 16, 2016

(54) Dynamic Spectrum Audio Encryption and Decryption Device

(71) Applicant: Ju Long Wei, Taichung City (TW)

(72) Inventor: Ju Long Wei, Taichung City (TW)

(21) Appl. No.: 14/870,375

(22) Filed: Sep. 30, 2015

(30) Foreign Application Priority Data
Dec. 12, 2014 (TW) 103143470

(51) Int. Cl. H04L 29/06; H04W 12/08

(52) U.S. Cl. CPC H04L 63/0428; H04W 12/08

(57) ABSTRACT

A dynamic spectrum audio encryption and decryption device is connected to a cell phone. The dynamic spectrum audio encryption and decryption device generates a communicating signal and encrypts the communicating signal so as to send to the cell phone. A remote cell phone received the communicating signal and sent to a corresponding remote dynamic spectrum audio encryption and decryption device and decrypts the communicating signal to generate a vocal voice output.

### BACKGROUND OF THE INVENTION

1. Field of Invention

The present invention is related to an audio encryption device, especially to a dynamic spectrum audio encryption and decryption device.

2. Description of the Related Art

Mobile device is getting important to our life. Many countries make a lot of efforts in protecting the security of private information transmission. However, technology development of eavesdropping and decryption is also improved rapidly, the security of private information transmission becomes more and more important and difficult nowadays.

Conventional encryption mobile device has an encryption module being integrated on the mobile device directly, which was normally used in special area such like military-use phones. However, users need to buy a pair of the encryption mobile devices to achieve a safe/private communication, which is troublesome and costly.

Recently, software Apps for mobile phones have been used for encryption in some smart phones. Installing encryption software in the mobile devices or storage devices, such as Micro SD, are commonly used for smart phone users. Although the software encryption is very convenient for users, but there has risks or loopholes existed since it is very easy to be installed a Trojan horse program or a Managers' Internal Control (MIC) program to brake the encryption. Therefore, software encryption is not a safety solution for protecting privacy preventing eavesdropping.

Therefore, there is a need for enhancing the security of private information transmission, so as to overcome the above-mentioned disadvantages.

### SUMMARY OF THE INVENTION

To solving the above-mentioned disadvantages, the present invention is related to an audio encryption device, especially to a dynamic spectrum audio encryption and decryption device. The audio encryption device provides a transmission interface for delivering messages by wireless, and provides an encryption procedure when delivering the messages.

The present invention is related to a dynamic spectrum audio encryption and decryption device being wirelessly connected with a cell phone, wherein

the dynamic spectrum audio encryption and decryption device receives a voice or video signal from a user, generates a communicating signal based on the voice or video signal, transmits the communicating signal to the cell phone after an encryption procedure processed; and

the dynamic spectrum audio encryption and decryption device receives a remote communicating signal from the corresponding cell phone, the communicating signal is played to the user after processed with the decryption procedure.

Base on the above mention, this invention includes the advantage as follows. A highly protected private secret communication between cell phones 20 may be easily achieved by using the dynamic spectrum audio encryption and decryption device 10. Software hackers are not possible to use software apps to recover the communicating signal from other cell phones 20, excepts using required information such like keys, sequences patterns and

aforementioned meanings. In the present invention, the encryption to the communicating signal is not identical all the time, hackers are not easy to

recovers the communicating signals properly in such a short time. The present invention also provide simplest encryption way by using a Bluetooth earphone. User need not to use a special cell phone to achieve a private communication.

Furthermore, this invention is not installed an application software into cell phone, but a wireless ear phone with hardware encryption function instead. User need not to change habituate in use but just use an extra ear phone or the like device that is able to being connected to the cell phone. All communication channels or methods are the same compared to traditional cell phone, such like GSM, WCDMA, CDMA2000, TCDMA or other analogue/digital

communication channels. Thus, a simplest and best encryption performance may be achieved by using the disclosure of this invention.

### BRIEF DESCRIPTION OF THE DRAWINGS

FIG. 1 is a system block diagram of a preferred embodiment of the present invention.

### DETAILED DESCRIPTION OF THE INVENTION

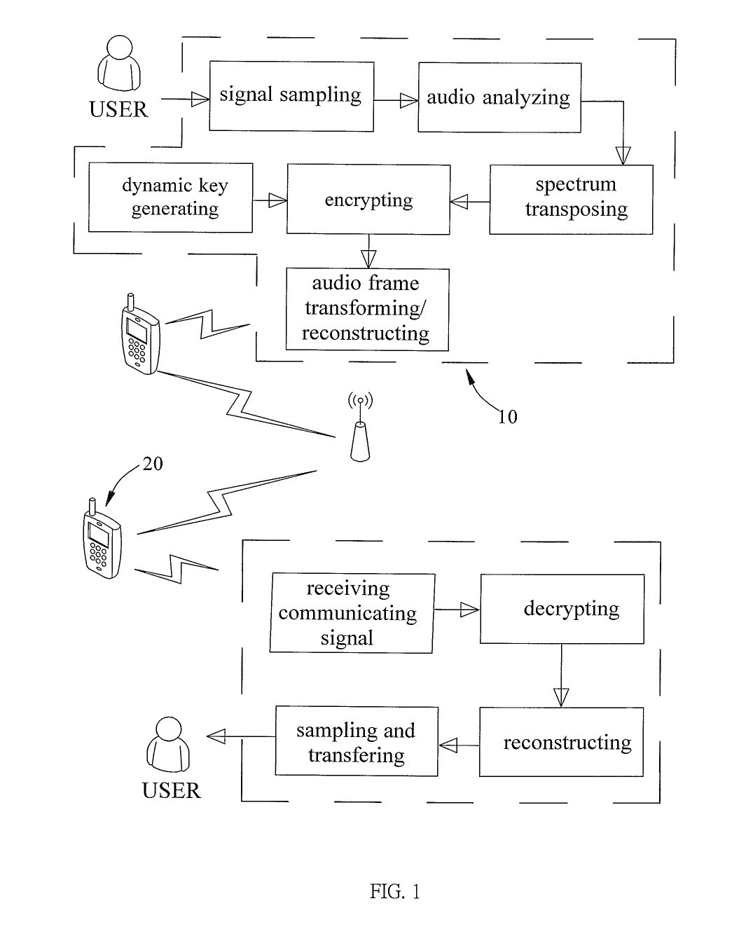

With reference to FIG. 1, a dynamic spectrum audio encryption and decryption device 10 in accordance with the present invention is wirelessly communicated with a cell phone 20 with Bluetooth, 2.4 GHz, Radio Frequency (RF) and the like communication channel or protocol. The cell phone may be a smart phone or the like mobile devices that using 2G, 3G or 4G communication networks.

The dynamic spectrum audio encryption and decryption device 10 may be communicated with the cell phone 20 with a full-duplex encryption/decryption communication.

The dynamic spectrum audio encryption and decryption device 10 receives a communicating signal and performs a decryption procedure and/or an encryption procedure to decrypts/encrypts the communicating signal. The communicating signal may be a voice signal or a video signal. The communicating signal is sent to the cell phone 20 after the encryption procedure. On the other hand, the dynamic spectrum audio encryption and decryption device 10 also received the communicating signal from the corresponding cell phone 20, The dynamic spectrum audio encryption and decryption device 10 decrypted the received communicating signal and played out to a user who wear the dynamic spectrum audio encryption and decryption device 10. The said communication signal is normally being a signal string.

In a preferred embodiment of the present invention, dynamic spectrum audio encryption and decryption device 10 is a wireless earphone set or a headphone. After build up a connection with the cell phone 20, the dynamic spectrum audio encryption and decryption device 10 decrypts the communicating signal received from the cell phone 20, the dynamic spectrum audio encryption and decryption device 10 decrypts the communicating signal and played to the user through a speaker of the dynamic spectrum audio encryption and decryption device 10. Thus, two users may use their own dynamic spectrum audio encryption and decryption devices 10 and corresponding cell phones 20 to transfer an encryption communication.

Communication with vocal communicating signals between remote and local cell phone 20 may be built through the telecommunication network like 2G, 3G or 4G, or on Internet.

In the preferred embodiment of the present invention, encryption/decryption procedure performed by the dynamic spectrum audio encryption and decryption device 10 is a hardware encryption/decryption for cell phones 20 communication. Video or voice signals were encrypted before transferring to the corresponded cell phone 20, the video or voice signal is kept confidential even the cell phone 20 was software virus attached or hacked.

Connection, communication and encryption/decryption procedure between the dynamic spectrum audio encryption and decryption device 10 and the corresponded cell phone 20 are illustrated as following steps:

Step of communication establishing—the dynamic spectrum audio encryption and decryption device 10 receives a communication request then set up a duplex audio channel with the corresponding cell phone 20.

Step of signal sampling—the dynamic spectrum audio encryption and decryption device 10 records the communicating signal of the user through a recorder, e.g., microphone, and then sampling the recorded communicating signal. The dynamic spectrum audio encryption and decryption device 10 may further performs the sampled communicating signal with a voice frame encoding procedure and temporary stores the processed communicating signal into a memory. The voice frame encoding procedure encodes the communicating signal as required voice quality and compressing ratio for providing better signal transferring efficiency. The objective to temporary stores, or queue or buffer the recorded communicating signal is to prevent discontinuously data transformation during communication.

Step of audio analyzing: the dynamic spectrum audio encryption and decryption device 10 performs an anti-compress analysis to isolation or identify a specific frequency band or specific audio frames from the communicating signal. The said specific frequency band or audio frames is speech signal or speech signal frequency band. The anti-compress analysis may uses RTE-LTP (regular pulse excitation-long-term prediction), AMR (Adaptive Multi-Rate), CELP (Code-excited linear prediction), or the like meanings to finish the analysis.

Normally, the voice signal strings transferred between cell phones 20 were reconstructed or compressed to increase the communication quality thereof. However, different cell phones 20 produced by different companies may use different methods to process the voice signal strings. Thus, the objective of the audio analyzing steps in accordance with the present invention is to analyze the communicating signals transferred between the cell phones 20, and let the coupled dynamic spectrum audio encryption and decryption device 10 and the corresponding cell phone 20 to use the same, similar or corresponded audio analyzing method to ensure the quality of the audio signal transformation.

Therefore, the communicating signal from the dynamic spectrum audio encryption and decryption device 10 transferred to coupled cell phone 20 was performed the audio analyzing step to identify the specific frequency band or specific audio frames.

Step of spectrum transposing—the dynamic spectrum audio encryption and decryption device 10 separates and groups the audio frames of the communicating signals and transfers the identified audio frames as spectrum matrixes. The communicating signal are grouped based on identity of the audio frames, such like speech signal or background signal or music signal, and then the communicating signal was transposed, arranged and assembled to form multiple spectrum matrixes. File sizes of the spectrum matrixes may be different to increase difficulty of breaking or reversing the communicating signal by hackers. A suitable computer processor should be used with regarding to the sizes of the matrixes. More matrix sizes may be used if the computer processor, such like Micro-processor, DSP processor, is better. In this steps, the communicating signal may also be transformed into signals in different domain. In the preferred embodiment of the present invention, the communicating signal may be transferred with Fourier transformation, the transformed audio frames of the communicating signals may preferably be rearrange sequence of the audio frames and then assembled as the matrix. Thus, a special sequence was adopted to prevent the hackers to recover the encrypted communicating signal. In this invention, sizes of the audio frame may be but not limited to be 60 ms, 120 ms, 256 ms or 512 ms.

Step of dynamic key generating—the dynamic spectrum audio encryption and decryption device 10 also generates a dynamic key. The dynamic key was transferred with the communicating signals and was delivered to remote cell phone 20 during building up communication channel between two cell phones 20. The two corresponded dynamic spectrum audio encryption and decryption device 10 have predefined private keys and use the transferred dynamic keys as public keys to decrypt the communicating signal. While the hacker intends to reverses the communicating signal, it is nearly not possible to get correct dynamic key in a short time since the dynamic key is continuously changed between two cell phones 20 communication. Even the corrected dynamic keys were used by the hacker, correct sequences of the audio frames/matrix sizes in the spectrum matrixes has to be recover at the same time to reverse communicating signal properly.

Step of audio frame transforming—the dynamic spectrum audio encryption and decryption device 10 may optionally perform a transforming encryption to transforms the audio frames to a different frequency band. Preferably, the audio frames is conjugate signals.

Step of audio frame reconstructing—the dynamic spectrum audio encryption and decryption device 10 may further perform a reconstructing procedure to reconstructs the audio frames as an unidentifiable communicating signal, thus the reconstructed communicating signal is not understandable even been hacked. In this step, the communicating signal is inserted a synchronic key accordingly for the remote dynamic spectrum audio encryption and decryption device 10 to reverse the reconstruction. Since the communicating signal with inserted synchronic key are all unidentifiable, hackers are not able to recover the reconstruction without knowing which part is the synchronic key. Thus, the security performance in the present invention is further improved.

Step of transmitting—the dynamic spectrum audio encryption and decryption device 10 transmits the processed communicating signal to the corresponding cell phone 20 and the processed communicating signal is transmitted to the remote cell phone 20 through mobile device communicating network. The remote cell phone 20 transfers received communicating signal to corresponded dynamic spectrum audio encryption and decryption device 10. The dynamic spectrum audio encryption and decryption device 10 recovers the processed communicating signal as identifiable communicating signal with performing reverse steps stated above.

Base on the above mention, this invention includes the advantage as follows. A highly protected private secret communication between cell phones 20 may be easily achieved by using the dynamic spectrum audio encryption and decryption device 10. Software hackers are not possible to use software apps to recover the communicating signal from other cell phones 20, excepts using required information such like keys, sequences patterns and aforementioned meanings. In the present invention, the encryption to the communicating signal is not identical all the time, hackers are not easy to recovers the communicating signals properly in such a short time. The present invention also provide simplest encryption way by using a bluetooth earphone. User need not to use a special cell phone to achieve a private communication.

Furthermore, this invention is not installed an application software into cell phone, but a wireless ear phone with hardware encryption function instead. User need not to change habituate in use but just use an extra ear phone or the like device that is able to being connected to the cell phone. All communication channels or methods are the same compared to traditional cell phone, such like GSM, WCDMA, CDMA2000, TCDMA or other analogue/digital communication channels. Thus, a simplest and best encryption performance may be achieved by using the disclosure of this invention.

What is claimed is:

1. A dynamic spectrum audio encryption and decryption device being wirelessly connected with a cell phone, wherein
the dynamic spectrum audio encryption and decryption device receives a voice or video signal from a user, generates a communicating signal based on the voice or video signal, transmits the communicating signal to the cell phone after an encryption procedure processed; and
the dynamic spectrum audio encryption and decryption device receives a remote communicating signal from the corresponding cell phone, the communicating signal is played to the user after processed with the decryption procedure.

2. The dynamic spectrum audio encryption and decryption device as claimed in claim 1, wherein the cell phone and the dynamic spectrum audio encryption and decryption device is bluetooth connected.

3. The dynamic spectrum audio encryption and decryption device as claimed in claim 1, wherein the dynamic spectrum audio encryption and decryption device is an ear phone or a head phone.

4. The dynamic spectrum audio encryption and decryption device as claimed in claim 1, the encryption procedure has steps comprising of:
encoding at least partial an audio frame of the communicating signal;
processing an anti-compress analysis to the communicating signal, and separating a specific frequency or audio frame in the communicating signal;
classifying the communicating signal being separated and rearranging the communicating signal to form multiple spectrum matrixes;
generating a dynamic key and encrypting the spectrum matrix with using the key;
rearranging the audio frame to generate the communicating signal with a synchronic signal; and
transmitting the rearranged communicating signal.

5. The dynamic spectrum audio encryption and decryption device as claimed in claim 4, wherein every spectrum matrix comprises different amount or length of audio frame.

6. The dynamic spectrum audio encryption and decryption device as claimed in claim 5, the length of the dynamic encryption/decryption key is generated randomly.
